(19) United States
(12) Patent Application Publication
(10) Pub. No.: US 2007/0076936 A1
(43) Pub. Date: Apr. 5, 2007

(54) Fast alignment of large-scale sequences using linear space techniques

(76) Inventors: Eric Li, Beijing (CN); Tao Wang, Beijing (CN); Yi Min Zhang, Beijing (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/240,763

(22) Filed: Sep. 30, 2005

(51) Int. Cl. G06K 9/00; G06K 9/62; G06F 19/00

(52) U.S. Cl. 382/129; 382/209; 702/20

(57) ABSTRACT

Large scale sequences and other types of patterns may be matched or aligned quickly using a linear space technique. In one embodiment, the invention includes, calculating a similarity matrix of a first sequence against a second sequence, determining a lowest cost path through the matrix, where cost is a function of sequence alignment, dividing the similarity matrix into a plurality of blocks, determining local start points on the lowest cost path, the local start points each corresponding to a block through which the lowest cost path passes, dividing sequence alignment computation for the lowest cost path into a plurality of independent problems based on the local start points, solving each independent problem independently, and concatenating the solutions to generate an alignment path of the first sequence against the second sequence.

### BACKGROUND

1. Field

The present description relates to aligning long sequences or patterns to find matches in sub-sequences or in portions and, in particular to using a grid cache and local start points to quickly find alignments of very long sequences.

2. Related Art

Sequence alignment is an important tool in signal processing, information technology, text processing, bioinformatics, acoustic signal and image matching, optimization problems, and data mining, among other applications. Sequence alignments may used to match sounds such as speech maps to reference maps, to match fingerprint patterns to those in a library and to match images against known objects. Sequence alignments may also be used to identify similar and divergent regions between DNA and protein sequences. From a biological point of view, matches point to gene sequences that perform similar functions, e.g. homology pairs and conserved regions, while mismatches may detect functional differences, e.g. SNP (Single Nucleotide Polymorphism).

Although efficient dynamic programming algorithms have been presented to solve this problem, the required space and time still pose a challenge for large scale sequence alignments. As computers become faster, longer sequences may be matched in less time. Multiple processor, multiple core, multiple threaded, and parallel array computing systems allow for still longer sequences to be matched. However, expanding uses of sequence alignment in information processing and other fields creates a demand for still more efficient algorithms. In bioinformatics, for example there is a great variety of organisms and millions of base pairs in each chromosome of most organisms.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a diagram of a similarity matrix for a first sequence S1 along the horizontal axis and a second sequence S2 along the vertical axis, showing trace-back paths;

FIG. 2A is a diagram of a portion of a similarity matrix showing sub-problems within portions of the matrix and a solution path through local start points according to an embodiment of the invention;

FIG. 2B is a diagram of a portion of a similarity matrix showing sub-problems within portions of the matrix and a solution path through local start points according to another embodiment of the invention;

FIG. 3 is a process flow diagram for aligning sequences using a sequential linear space algorithm according to an embodiment of the invention;

FIG. 4 is a process flow diagram for aligning sequences using a parallel linear space algorithm according to an embodiment of the invention;

FIG. 5A is a diagram of processing a block of a similarity matrix at a first time step according to an embodiment of the invention;

FIG. 5B is a diagram of processing blocks of the similarity matrix of FIG. 5A at a second time step according to an embodiment of the invention;

FIG. 5C is a diagram of processing blocks of the similarity matrix of FIG. 5A at a third time step according to an embodiment of the invention;

FIG. 6A is a diagram of a portion of a similarity matrix showing sub-problems within portions of the matrix and two solution paths through local start points according to an embodiment of the invention;

FIG. 6B is a diagram of the sub-problems of FIG. 6A isolated from the similarity matrix according to an embodiment of the invention;

FIG. 6C is a diagram of the sub-problems of FIG. 6B in which one of the sub-problems has been divided into smaller problems according to an embodiment of the invention;

FIG. 7 is a block diagram of a PC cluster suitable for implementing embodiments of the present invention; and

FIG. 8 is a block diagram of computer system suitable for use in the PC cluster or for stand-alone use for implementing embodiments of the present invention.

### DETAILED DESCRIPTION

1. Introduction

In one embodiment, the invention for large-scale sequence alignment may be referred to as “SLSA” (Sequential Linear Space Algorithm). In SLSA, re-calculations are reduced by grid caches and global and local start points thereby improving overall performance. First, a whole similarity matrix H(i, j) is calculated in a linear space. The information on grids, including global and local start points and similarity values, are stored in grid caches. Then, the whole alignment problem is divided into several independent sub-problems. If a sub-problem is small enough, it will be solved directly. Otherwise, it will be further decomposed into several smaller sub-problems until the smaller sub-problems may be solved in the available memory. Using the global start points, several (k) near-optimal non-intersecting alignments between the two sequences can be found at the same time.

The grid cache and global and local start points used in SLSA, are efficient for large-scale sequence alignment. The local start points and grid cache divide the whole alignment problem into several smaller independent sub-problems, which dramatically reduces the re-computations in the backward phase and provides more potential parallelisms than other approaches. In addition, global start points allow many near-optimal alignments to be found at the same time without extra re-calculations.

In another embodiment, the invention for large-scale sequence alignment may be referred to as “Fast PLSA” (Fast Parallel Linear Space Alignment). Based on the grid cache and global and local start points, mentioned above, Fast PLSA provides a dynamic task decomposition and scheduling mechanism for parallel dynamic programming. Fast PLSA reduces sequential computing complexity by introducing the grid cache and global and local start points, and provides more parallelism and scalabilities with dynamic task decomposition and scheduling mechanisms.

Fast PLSA may be separated into two phases: a forward phase and a backward phase. The forward phase uses wave front parallelism to calculate the whole similarity matrix H(i, j) in linear space. The alignment problem may then be segmented into several independent sub-problems. The backward phase uses dynamic task decomposition and scheduling mechanisms to efficiently solve these sub-problems in parallel. This scheme can achieve automatic load balancing in the backward trace back period, tremendously improving the scalability performance especially for large scale sequence alignment problems.

2. Sequential LSA

Referring again to embodiments of the invention that may be characterized as Sequential LSA, for two sequences S1 and S2 with length l1 and l2, the Smith-Waterman algorithm (Temple F. Smith and Michael S. Waterman, Identification of Common Molecular Sub-sequences, Journal of Molecular Biology, 147:195-197 (1981)) computes a similarity matrix H(i, j) to identify optimal common sub-sequences by the using equation set 1, below:

$$\begin{matrix}H ( i , j ) = max \{ \begin{matrix}0 \\ E ( i , j ) \\ F ( i , j ) \\ H ( i - 1 , j - 1 ) + sbt ( S {1}_{i} , S {2}_{j} )\end{matrix} \\ E ( i , j ) = max \{ \begin{matrix}H ( i , j - 1 ) - α \\ E ( i , j - 1 ) - β\end{matrix} \\ F ( i , j ) = max \{ \begin{matrix}H ( i - 1 , j ) - α \\ F ( i - 1 , j ) - β\end{matrix} \\ with H ( i , 0 ) = E ( i , 0 ) = 0 , 0 \leq i \leq {l}_{1} \\ H ( 0 , j ) = F ( i , 0 ) = 0 , 0 \leq j \leq {l}_{2}\end{matrix} \qquad ( 1 )$$

where 1≦i≦l₁, 1≦j≦l₂ and sbt( ) is the substitution matrix of cost values. Affine gap costs are defined as follows: α is the cost of the first gap, and β is the cost of the following gaps. H(i, j) is the current optimal similarity value ending at position (i, j). E and F are the cost values from a vertical or horizontal gap respectively. An example is illustrated in FIG. 1, where forward processing fills the similarity matrix H and the backward processing traces back the optimal alignment path.

FIG. 1 shows the two sequences S1 (ATCTCGTATGATG) and S2 (GTCTATCAC) presented on the horizontal and vertical axes, respectively, of a similarity matrix. In the example of FIG. 1, k is set to 2. k refers to the number of near-optimal alignments. The substitution cost if two characters are identical is +2 and otherwise, the substitution cost is −1. The first gap penalty and the extension gap penalty are −1. For the example sequences S1 and S2, FIG. 1 shows that there are two traceback paths 101, 102 that deliver non-intersecting optimal and near-optimal alignments.

The memory required to solve the Smith-Waterman algorithm has been characterized as O(l1×l2), i.e. some independent factor (O) multiplied by the product of the length of each sequence (l1, l2). To align sequences with several hundred million elements, e.g. genome alignment, would lead to a memory requirement of several terabytes. Various different approaches have been developed to reduce the memory requirement. These usually increase the processing demands or reduce accuracy.

Fast LSA (Adrian Driga, Paul Lu, Jonathan Schaeffer, Duane Szafron, Kevin Charter and Ian Parsons, Fast LSA: A Fast, Linear-Space, Parallel and Sequential Algorithm for Sequence Alignment, In the International Conference on Parallel Processing, (2003)) uses some extra space called grid cache to save a few rows and columns of the similarity matrix H (see e.g. FIG. 1), and then divides the whole problem into several sub-problems. Saving the grid cache reduces the amount of re-computation, however, the sub-problems are still large and inter-related. Sequential LSA uses the grid cache and local start points of Fast LSA to divide the whole problem into smaller, independent sub-problems, which provides more parallelism than other methods.

2.1 k Near-Optimal Alignments and Global Start Points

The Smith-Waterman algorithm only computes the optimal local alignment result. However, the detection of near-optimal local alignments is particularly important and useful in practice. Global start point information may be used to find these different local alignments. The recurrences equation of the global start points is slightly inconvenient since it requires more computation and memory. However, the recurrences equation may be simplified as described below.

For each point (i, j) in the similarity matrix H, define the global start point Hst(i, j) as the starting point of the local alignment path ending at point (i, j). Similar to Eq (1), the values of Hst(i, j) may be calculated using the recurrence equations of equation set 2, below:

$$\begin{matrix}Hst ( i , j ) = \{ \begin{matrix}( i , j ) & if H ( i , j ) = 0 \\ Hst ( i - 1 , j - 1 ) & if H ( i , j ) = \\ & H ( i - 1 , j - 1 ) + sbt ( S {1}_{i} , S {2}_{j} ) \\ Est ( i , j ) & if H ( i , j ) = E ( i , j ) \\ Fst ( i , j ) & if H ( i , j ) = F ( i , j )\end{matrix} \\ Est ( i , j ) = \{ \begin{matrix}Hst ( i , j - 1 ) & if E ( i , j ) = H ( i , j - 1 ) - α \\ Est ( i , j - 1 ) & if E ( i , j ) = E ( i , j - 1 ) - β\end{matrix} \\ Fst ( i , j ) = \{ \begin{matrix}Hst ( i - 1 , j ) & if F ( i , j ) = H ( i - 1 , j ) - α \\ Fst ( i - 1 , j ) & if F ( i , j ) = F ( i - 1 , j ) - β\end{matrix}\end{matrix} \qquad ( 2 )$$

In order to determine k near-optimal alignments, the k highest similarity scores with different global start points are recorded during the forward period. If one of the k highest scores ends at a point (iₘₐₓ, jₘₐₓ), then its global start point Hst(iₘₐₓ, jₘₐₓ) can be easily obtained according to the stored information. The near optimal paths can be traced back in the rectangle of the two points. These near optimal paths with k highest scores will not intersect with each other. If the near optimal paths do intersect, then they must have the same global start point.

Using the start points, all of the k near-optimal alignments may be found at the same time without introducing extra re-computations. In addition, both the global and local alignment problem may be solved.

2.2 Grid Cache and Local Start Points.

For many processing systems, the system memory is not large enough to contain the complete similarity matrix for long sequences. A partial similarity matrix H may then be re-computed in the backward phase. To reduce re-calculations, a few columns and rows of the matrix H may be stored in k×k grid caches.

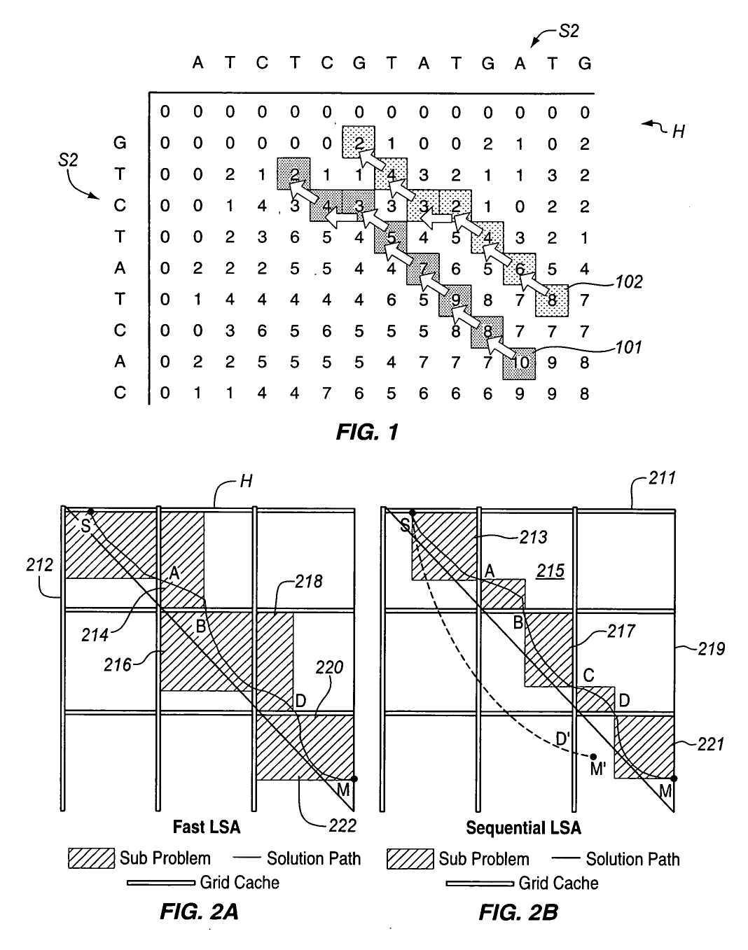

FIG. 2A shows a portion of the overall similarity matrix H, divided into square k×k grid caches 212, 214, 216, 218, 220. In the case of FIG. 2A, k=3. After the end point M of the optimal path is found, the last bottom-right sub matrix 220 will be recalculated and a trace path 222 will be performed back to find the intersection point D of the solution with the grid cache boundary. Similarly, to trace the path back through the next grid cache to point C, the grid cache 218 above the point D and also the grid cache to the left of that one 216 are re-calculated. The re-calculation is repeated through points B and A, back to the global starting point S. The shaded rectangles in FIG. 2A indicate the sub-problems where re-computations have to be performed.

The sub-problems can be processed only after the last sub-problem, the adjacent bottom-right grid cache 222, is solved. After all of the sub-problems are solved recursively, the sub-paths may be concatenated to form the full optimal alignment path 222.

In combination with grid caches, local start points may be used to generate smaller and independent sub-problems. Similar to the global start point described above, the local start point of one point (i, j) may be defined as the starting position in its left/up grid of the local alignment ending at point (i, j). The local start point may be calculated by Eq (2) with different initialization on the grids. Using the grid cache and local start points, the whole alignment problem can be divided into several independent sub-problems.

As shown in FIG. 2B, when discovering the maximal score point M, the local start point D may be obtained from its point information. Subsequently, C may be determined as the local start point of D. The determination of local start points may be performed recursively to find all the local start points in order from M to D to C to B to A to S, the global start point. These local start points form a few independent rectangular sub-problems represented by the shaded part of each grid cache 213, 215, 217, 219, 221 in FIG. 2B. The sub-problems are independent so that they may be solved in parallel and therefore more quickly than the sub-problems in FIG. 2A. In addition, the sub-problems of FIG. 2B are smaller than those of FIG. 2A due to the use of local start points. This combines with the benefit of using fewer re-computations.

2.3 Solving Sub-Problems

In order to improve the trade-off between time and space, a block may be used as the basic matrix filling and tracing path unit. The block, similar to a 2D matrix, denotes a memory buffer which is available for solving small sequence alignment problems. If a problem or sub-problem is small enough, it may be directly solved within a block. Otherwise it will be further decomposed into several smaller sub-problems until the sub-problems are small enough to easily be solved. Since the start and end points are fixed in the sub-problem, it becomes a global alignment problem. For global alignment, the computation of the score H(i, j) may be given by the recurrences of equation set 3, below.

$$\begin{matrix}H ( i , j ) = max \{ \begin{matrix}E ( i , j ) \\ F ( i , j ) \\ H ( i - 1 , j - 1 ) + sbt ( S {1}_{i} , S {2}_{j} )\end{matrix} \\ E ( i , j ) = max \{ \begin{matrix}H ( i , j - 1 ) - α \\ E ( i , j - 1 ) - β\end{matrix} \\ F ( i , j ) = max \{ \begin{matrix}H ( i - 1 , j ) - α \\ F ( i - 1 , j ) - β\end{matrix}\end{matrix} \qquad ( 3 )$$

In order to improve performance, the block size may be tuned to suit different memory size and cache size configurations. All of the sub-problems may be solved in parallel for faster speed since they are independent of each other. After all the sub-problems are solved, the traced sub-paths may be concatenated to produce a full optimal alignment path.

In sum, Sequential LSA, as described herein represents a fast linear algorithm for large scale sequence alignment. The joint contribution of the grid cache and global and local start points, allow a large-scale alignment problem to be recursively divided into several independent sub-problems until each independent sub-problem is small enough to be solved. This approach dramatically reduces the re-computations in the backward phase and provides more parallelism. In addition, using global start points can efficiently find k near-optimal alignments at the same time.

2.4 Pseudo-Code for Sequential LSA

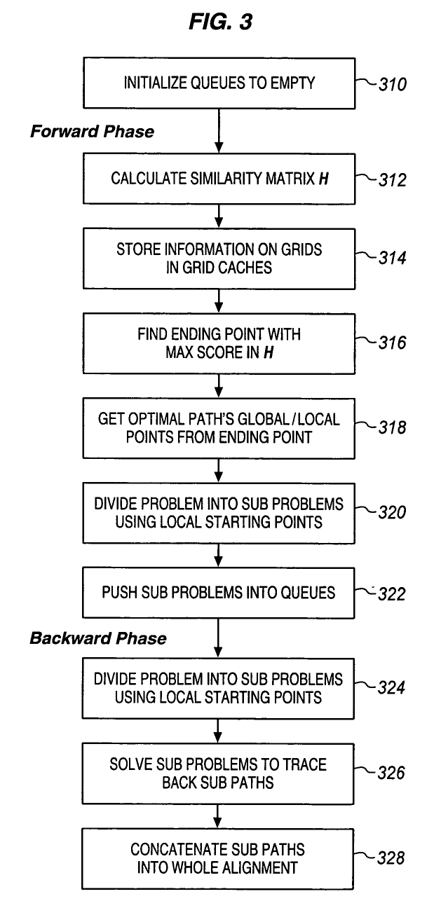

The Sequential LSA approach described above may be represented, in one example, by the flow chart of FIG. 3. The block of FIG. 3 may represent program instructions, software modules or hardware components. In FIG. 3, at block 310, the queues for all problems are initialized. In this embodiment, there are queues for the problems to be solved (solvable problem queue) and queues for the problems that are too large or time-consuming for the hardware to easily solve (unsolvable problem queue).

The forward phase begins with block 312 by calculating a similarity matrix H for an input pair of sequences that are to be compared. Information about the grids of matrix H is then stored in grid caches at block 314. This information may include global and local start points and similarity values. The grids may be based on a block size and grid division that may be set before the alignment process is started. At block 316, the ending point that has the maximum score in H is found and then the optimal path may be identified based on the global starting point and the found ending point. The local points may also be found based on the optimal path at block 318.

The whole problem may then be divided into sub-problems using the local start points at block 320. The sub-problems may then be pushed into problem queues at block 322. If the sub-problem can be solved within a block size, then it is pushed to a solvable problem queue. If the sub-problem cannot be solved within a block size, then it is pushed into an unsolvable problem queue.

The backward phase begins by processing the problems in the unsolvable problem queues at block 324. This may be done in the same way as in the forward process. The processing may divide the unsolvable problems into smaller sub-problems based on local starting points until they can be solved within a block size. Then the problems may be pushed into solvable problem queues. At block 326, the sub-problems in the solvable problem queues are solved and the sub-paths are traced backwards to find the sub-alignment paths. At block 328, when all the sub-problems are solved then all the sub-alignments are concatenated into a final alignment solution.

A process such as that of FIG. 3 may also be represented by the following pseudo-code:

Input: sequence 1, 2; block size (h, w); grid division (rows, cols); Output: optimal alignment path

Initialize unsolvable problem queue and solvable problem queue to empty.

1. Forward process:

1.1 Calculate the whole similarity matrix H in linear space. The information on grids, including global/local start points and similarity value, are stored in the grid caches.

1.2 Find the ending point with max score in H and get the optimal path's global/local points from the ending point.

1.3 Divide the whole problem into independent sub-problems by these local start points

1.4 Push these sub-problems into a queue depending on whether they can be directly solved within a block size or not.

2. Backward process:

2.1 Process each unsolvable sub-problem in the unsolvable problem queue using the same strategy as the forward process until the sub-problems are solvable.

2.2 Solve the sub-problems in the solvable problem queue to trace back the sub-paths.

2.3 If all the sub-problems are solved, concatenate all solutions into output alignment path.

3. Fast Parallel Linear Space Algorithm (Fast PLSA)

In another embodiment, an approach denoted FastPLSA uses the grid cache and global start point described above to reduce the sequential execution time and to provide more parallelism especially when coping with the trace back phase. In addition, Fast PLSA can output several near-optimal alignment paths after one full matrix filling process. It also introduces several tunable parameters so that the whole process can adapt to different hardware configurations, such as cache size, main memory size and the different communication interconnections, data rates and speeds. FastPLSA is able to use more available memory to reduce the re-computation time for the trace back phase.

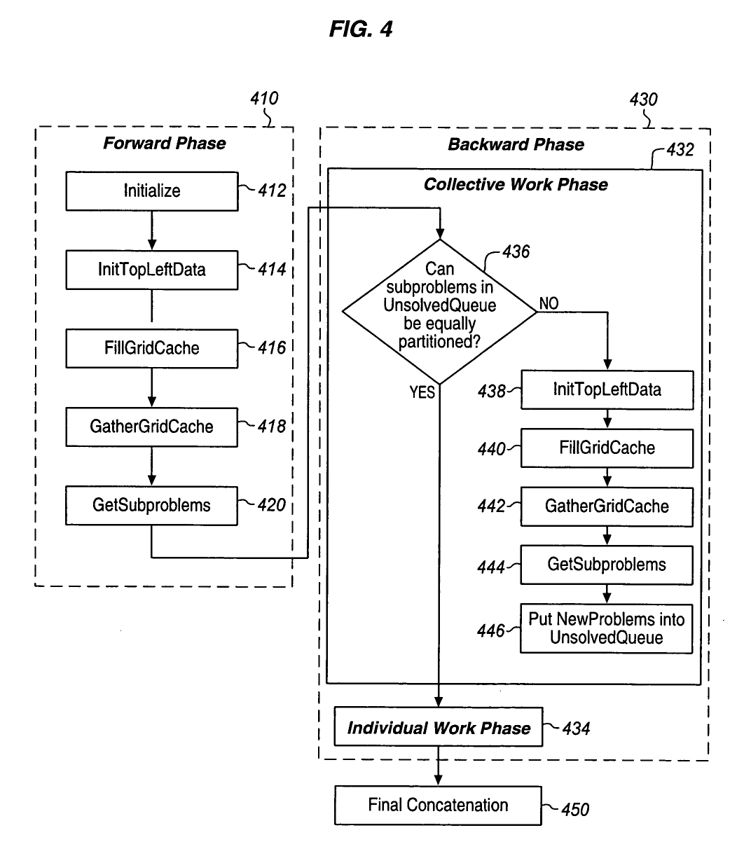

To further improve alignment performance, the Sequential LSA algorithm may be parallelized using a Fast PLSA approach. Large scale sequence alignments may be mapped to a parallel processing architecture in two parts. The first part is forward calculating the whole similarity matrix and the second part is backward solving sub-problems to find trace path phase. FIG. 4 is a flowchart of one example of aligning sequences in a parallel implementation. The blocks of FIG. 4 may represent lines of code, software modules or separate hardware modules.

3.1 Forward Phase

In the forward phase, block 410 of FIG. 4, the alignment matrix block performs as the elementary unit to compute the whole sequence alignment based on the full matrix filling method. The grid caches, including the position, score and local and global start point information will be recorded at the same time. In addition, k maximal positions may be saved and updated during this period. After that, this information may be used to decompose the whole problem into a series of independent sub-problems and solve the independent sub-problems as global sequence alignment problems.

The forward phase begins with initializing all of the values for memory grid size, problem queues etc. at block 412. The computation of each block follows the dynamic programming of equation set 1 to fill the block matrix. The whole similarity matrix may be built by first initializing the values of the leftmost column and topmost row at block 414. The top left block may then be computed immediately. Since each block has dependencies on its adjacent left, upper left and upper blocks according to equation set 1, it may be processed at block 416 after its adjacent related blocks are computed. Based on such a dependency model, a wave front communication pattern can be used in the parallelization of the similarity matrix.

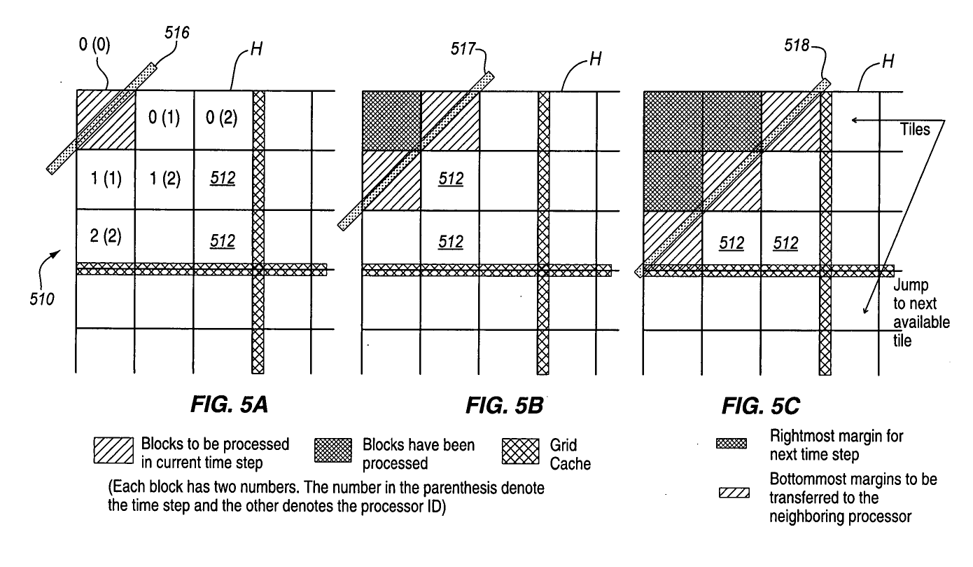

The wave front moves in anti-diagonals as depicted in FIGS. 5A, 5B,and 5C. FIG. 5A shows a portion of the similarity matrix with one full grid cache 510 made up of nine blocks 512. The top left block (0,0) of the top left grid cache is designated as the global starting point and the shift direction is from the top left (or north-west) to the bottom, right (or south-east). A diagonal wave front 516 indicates the processing direction. After the top left block is computed, the processing may proceed along the diagonal wave front to the next two blocks.

FIG. 5A shows the computation of blocks during a first time step by one processor. After the first time step, the processing moves to the next two blocks (0,1) and (1,1) as shown in FIG. 5B. The diagonal wave front 517 of FIG. 5B has moved down by one block toward the bottom right. The processing of the two blocks may be done in parallel by two different processors. After the second time step, the processing of the next two blocks is finished, and the diagonal wave front 518 moves down to the next set of blocks as shown in FIG. 5C. Three blocks (0,2), (1,2), and (2,2) may be processed based on the results for the first three blocks. Three different processors may process these three blocks in parallel. As the diagonal wave front moves across the similarity matrix H more processors may be used with each time step.

The wave front computation may be parallelized in several different ways depending upon the particular parallel processing architecture that will be used. On fine-grained architectures such as shared memory systems, the computation of each cell or a relatively smaller block within an anti-diagonal may be parallelized. This approach works better for very fast inter-processor communications since the granularity for each processing unit is extremely small. On the other hand, for distributed memory systems such as PC clusters, it may be more efficient to assign a relatively larger block to each processor. In one example, two parameters h and w are used to denote the height and width of each block in terms of cells. These may be tuned to adapt to different architectures.

In the Fast PLSA example of FIG. 4, a FillGridCache procedure at block 416 performs block calculations, storing and updating k maximal cells and filling grid cache tasks. In some applications this may be the most time-consuming module in the process flow diagram, taking up almost 99.5% of the total execution time. In order to better exploit the data locality and minimize the communication overhead, a tile based processing scheme may be used in the wave front parallelization. In this embodiment, a tile is a bundle of blocks consisting of complete horizontal blocks, which are to be processed on a single processor. Once a processor finishes computing a block, it continues to process all the remaining blocks in a tile until the tile is empty. Then the processor proceeds to work on the next available tile.

Referring to FIG. 5A, a portion of a grid cache is shown that has been divided into blocks. The upper right block is denoted block (0,0). The parallel processing must begin at some point and in one embodiment it begins with block (0,0). If this block is used for the initial values, then a first processor will work on block (0,0) at the beginning of the FillGridCache process while all the other processors are idle or busy with unrelated tasks. After block (0,0) has been finished, the bottom margin of block (0,0) may be transferred to a second processor and the first processor may moves on to compute block (0,1) in this tile.

The second processor may use the transferred margin as the initial top margin of block (1,0) and the right margin of block (0,0) may be used as the initial left margin of block (0,1). In this way, block (0,1) and block (1,0) may be computed by the first and second processors simultaneously as soon as block (0,0) is completed.

Similarly, additional processors may process additional blocks at the same time. The processing of these tiles advances on a diagonal wave front 516, 517, 518, and more of the processors can be added to work in parallel as the diagonal wave front progresses. If there are P processors in total and it requires one time step per tile, then all P processors are operating after (P-1) time steps.

Along with the block computing, the grid cache may be saved when a part of the grid columns or rows is within a computing block. Since the grid cache is distributed among all the processors, a procedure denoted in FIG. 4 as GatherGridCache 418 may be used to collect all the distributions of the grid cache to a root processor. Under the GatherGridCache procedure, the local maximal k cells in each processor are gathered at about the same time and sorted to select the global maximal k score cells. Finally, a GetSub-problems 420 procedure may be used to find all the segmented sub-problems and put them into the unsolvable problem queue. The unsolvable problem queue may be processed in the backward phase.

In many implementations, each block will have two communication operations, receiving the bottom marginal data from the upper block and sending the upper block's marginal data to the bottom block. The communication overhead may be reduced especially in a PC cluster by using non-blocking receive message passing operations to overlap the communication overhead with computing. The receive message passing operations may work like a pipeline block by block until the whole similarity matrix H is filled. This minimizes the communication cost and delivers better parallelization performance.

3.2 Backward Phase

After the forward phase 410, a series of independent sub-problems are stored in the unsolvable problem queue. For each sub-problem, a global alignment technique may be used in a backward phase 430 to solve these sub-problems and concatenate these alignments to the optimal path. Sub-problem alignment may be solved by a repeated process of the forward phase. However, there may be several differences between forward and backward phases.

a) Since the start and end points of the optimal alignment paths are unknown in the forward phase, a Smith-Waterman algorithm may be used to fill the whole similarity matrix and find all the sub-problems. In the backward phase, each sub-problem has fixed start and end points, so, for example, a Needleman-Wunsch algorithm may be used to find global alignment of these sub-problems. Saul B. Needleman and Christian D. Wunsch. “A General Method Applicable to the Search for Similarities in the amino acid Sequence of Two Sequences” Journal of Molecular Biology, 48:443-453 (1970).

b) Different parallel schemes may be used in the forward phase and the backward phase. The forward phase may use wave front parallelism as described above. In the backward phase, since all the sub-problems are independent of each other, more factors, may be considered such as the size of sub-problems and the number of processors. Factors may also be combined to derive better parallel schemes. Attention to the load balance performance to efficiently use all the processors in the backward period may be particularly effective because the backward phase's granularity is much finer than the forward phase's granularity.

c) For large scale alignment problems, in general, the problem may be divided into several sub-problems in the forward phase. In the backward phase, if the sub-problem size is smaller than the block size, it may be directly solved by using the full matrix filling method. Otherwise, approaches similar to those used in the forward phase may be used to subdivide sub-problems.

The differences between the forward phase and the backward phase allow the two phases to be tailored differently to improve computational efficiency, accuracy and speed. In one implementation, the sub-problems may be evenly and independently distributed to all of the processors. Each processor then works on a sub-problem using the sequential methods described above. After the sub-problems are solved, the processors collect the sub-alignments together and concatenate them to the optimal alignment.

To better balance the processing load among the processors, each sub-problem may first be recursively decomposed in a wave front parallel scheme until all the descendant sub-problems are reduced to the block size and can be quickly solved. This recursive decomposition may be applied to each sub-problem in turn. This scheme is particularly effective for small scale processors or large scale sub-problems. Many modifications and variations may be made to these and the other approaches described above to consider both the load balance as well as the granularity of the problems in the backward parallel phase, and to design a flexible scheme to partition tasks equally for all the processors.

In one embodiment as shown in FIG. 4, a particular flexible scheme may be used to better exploit load balance and problem granularity by dynamically partitioning all of the sub-problems. In this embodiment, the backward phase may be further separated into two periods: a collective solving sub-problem phase 432 and an individual solving sub-problems phase 434. During the collective solving phase, the unsolved sub-problem queue may be checked to determine whether it is in a “balanced state” or not at block 436.

The “balanced state” means that all of the sub-problems may be distributed roughly equally to all the processors within some threshold (e.g. 20%). In other words, the “balanced state” indicates that the difference of the sum area of the sub-problems assigned to each processor are within the threshold value. If, for example, the unsolved sub-problem queue consists of four sub-problems of different sizes (100×100, 50×50, 70×70 and 110×100) to be assigned to two different processors, then to evenly distribute tasks between these two processors, the first processor may be assigned the 100×100, and 70×70 tasks, and the second processor may be assigned the 50×50 and the 110×100 sub-problems respectively. The size difference ratio may be computed for the two processors, and the value (14900-13500)/13500=10.3% is smaller than the default threshold. Therefore, the unsolved sub-problem queue is in the “balanced state”.

In one embodiment, a formula may be applied to determine whether the sub-problems in the queue are in the “balanced state” as shown in equation set 4, below:
Size_{average}=ΣSizeᵢ/M, where the sum is for i=0 to M (4)
|(Sizeₚⱼ−Size_{average})/Size_{average}|<Threshold, 1≦j≦M
where M is the total processor number and N is the sub-problem number. Sizeᵢ is the area for each sub-problem and Sizeₚⱼ is the total area of sub-problems assigned to the jth processor. If the difference of the sum area of the sub-problems assigned to each processor is within the Threshold value (in one embodiment, a default value may be 20%), the sub-problems can be considered to enter the “balanced state”, indicating that the sub-problems are distributed equally to each processor.

If the unsolved sub-problem queue is not in the “balanced state”, then the largest size sub-problem from the queue may be found and decomposed into several smaller descendant sub-problems with wave front parallelism. After that, the descendant sub-problems may be pushed back into the unsolved problem queue. The balanced state test may then be iterated to detect whether the queue is again in the “balanced state” or not.

Referring to FIG. 4, the initial top left block of the diagonal wave front is operated on at block 438. The grid cache for that block is filled at block 440. At block 442, the grid data distributed to all of the involved processors is gathered. At block 444, the sub-problems are gathered together and at block 446 placed into the unsolved sub-problem queue. The collective work phase then returns to determine whether the new problems in the unsolved sub-problem queue can be distributed to the various processors.

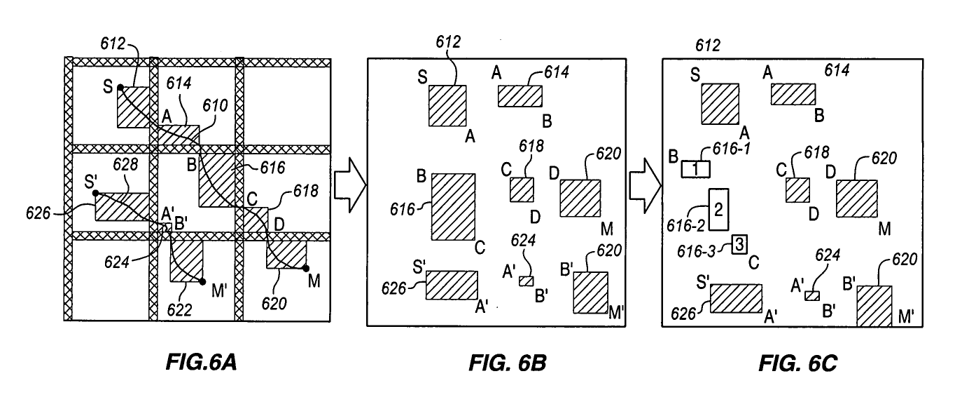

FIGS. 6A, 6B, and 6C demonstrate the collective phase diagrammed in FIG. 4. In FIG. 6A, the forward phase has segmented 8 sub-problems 612. The first five sub-problems 612, 614, 616, 618, 620 are associated with one alignment 610. The remaining three sub-problems 622, 624, 626 are associated with a second alignment 628.

In FIG. 6B, the problems are shown disassociated from the grid cache. This allows the relative sizes to be more easily observed. If the unsolved sub-problems cannot be distributed equally to all the processors, then the largest block 616, the one connecting local start points B and C in FIG. 6A, may be decomposed into some smaller descendent sub-problems 616-1, 616-2, 616-3 as shown in FIG. 5C. This decomposition process proceeds until all the available sub-problems can be approximately equally assigned to all the processors.

After the unsolved sub-problem queue is in the “balanced state,” the individual solving sub-problem phase 434 of FIG. 4 is entered. During this phase, each processor is approximately assigned with equal size sub-problems and solves them independently using the sequential method as described above. Finally, after all the sub-problems have been solved, the sub-sequence alignment results may be collected and concatenated to the final optimal alignment paths at block 450.

3.4 Pseudocode for Fast PLSA

A process such as that of FIG. 4 may also be represented by the following pseudo-code:

Input: sequence 1, 2; block size (h, w); grid division (rows, cols); Output: optimal alignment path

Forward process:

1.1 Calculate the whole similarity matrix H in linear space with wave front parallel scheme.

1.2 The information on grids, including global/local start points and similarity value, are stored in the grid caches.

1.3 Collect all the distributed grid cache information to the root processor.

1.4 Find the ending point with max score in H and get the optimal path's global/local start points from the ending point.

1.5 Divide the whole problem into independent sub-problems by these local start points

1.6 Push all these sub-problems into the “unsolved queue”

2. Backward Process:

2.1 If all the sub-problems in the “unsolved queue” can be distributed to the processors equally, pick out the largest sub-problem and subdivide it into a series of smaller sub-problems using the same strategy as the forward process.

2.2 Push all of those decomposed sub-problems back into the “unsolved queue”, go back to 2.1

2.3 Otherwise, go directly into the individual work phase, where all the sub-problems in this queue will be proximately assigned to the working processors.

2.4 Each processor will work independently to find the sub alignment paths for the assigned sub-problems.

3. Concatenate all the sub alignments individually on each processor, and finally, merge them together into the final one.

The Fast PLSA approach produces k near-optimal maximal non-intersecting alignments within one forward and one backward phase. The speedup in k alignments (k>1) is usually better than for a single alignment. This may be because the forward phase execution time is relatively stable and more sub-problems can be generated when the number of output alignments is increased. In the example of FIG. 6A, two paths produce 8 sub-problems whereas one path can only generate 5 sub-problems. With more sub-problems, the “balanced state” may be entered more quickly because fewer sub-problems need to be decomposed into smaller problems. Accordingly, parallel performance in the backward phase is improved with a larger number of alignments.

The described approaches allow for long sequence alignments to be performed more quickly using linear space. A trade is made to increase space to reduce time. The local start points and grid cache can divide the whole sequence alignment problem into several independent sub-problems, which dramatically reduces the re-computations of the trace back phase and provides more parallelism. The dynamic task decomposition and scheduling mechanism can efficiently solve the sub-problems in the backward phase. This tremendously improves the scalability performance and minimizes the load imbalance problem especially for large scale sequence alignment.

4 Processing Environment

The approaches described above may be carried out on a variety of different processing environments. In one embodiment, a 16-node PC cluster interconnected with a 100 Mbps Ethernet switch may be used. Each node has a 3.0 GHz Intel Pentium-4 processor with 512 KB second-level cache and 1 GB memory. The RedHat 9.0 Linux operation system and MPICH-1.2.5 message passing library (Message Passing Interface from Mathematics and Computer Science Division, Argonne National Laboratory, Illinois) may be used as the software environment. The sequence alignment routines may be written in C++ or any other programming language or implemented in specialized hardware.

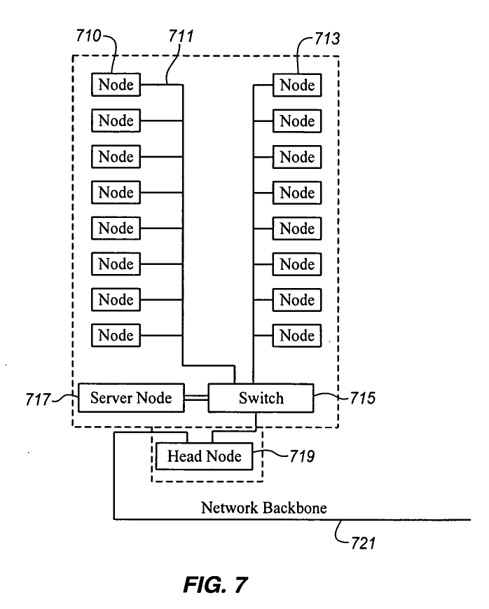

FIG. 7 is a generalized diagram of a 16 node PC cluster. There are two columns of PCs 710, 713, coupled together through network cabling 711, 712, such as Ethernet to a router or switch 715. Each node may be based on a conventional microcomputer or PC architecture with a bus based network interface card, such as a PCI (Peripheral Component Interconnect) network adapter. The switch 715 may also be coupled to a server node 717 to serve large data files to the nodes and to a head node 719 to control the system. In one embodiment, the head node has a user interface, such as a keyboard and display that provides access to the server node and each of the other 16 nodes in the PC cluster. In another embodiment, each node has its own user interface. The PC cluster may be coupled to a network backbone 721 to communicate with other computer systems through the head node or through the switch.

The particular architecture of FIG. 7 is provided as an example of a parallel processing system that may be applied to the present invention. Embodiments of the invention may also be applied to multithreaded, single processor systems, to multiple core, single processor systems, to multiple processor systems of many different types and to multiple node systems with differing numbers and types of nodes, different operating systems, different connections and different architectures.

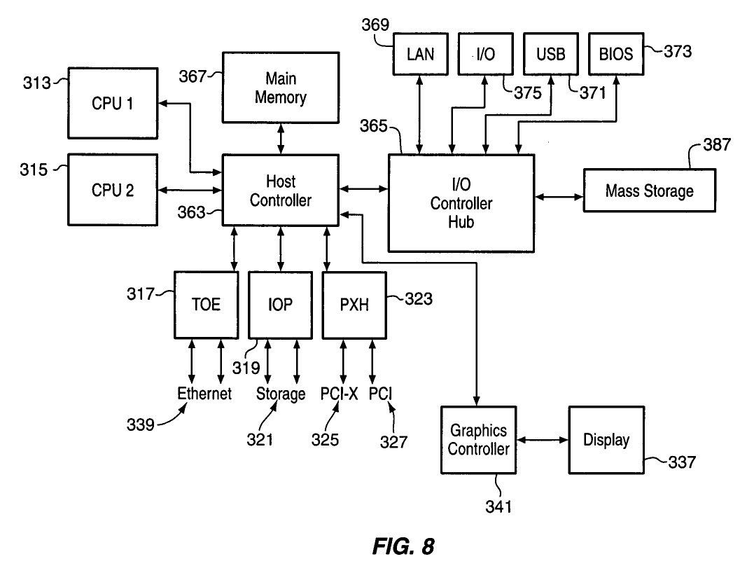

FIG. 8 provides an example of a computer system that may be used as a node, server node or head node of FIG. 7 or of other types of processing systems. In the example system of FIG. 8, an MCH (Memory Controller Hub) 311 has a pair of FSBs (front side bus) each coupled to a CPU or processor core 313, 315. More or less than two processors, processor cores and FSBs may be used. In one embodiment, the multiple processors mentioned above for the forward and the backward path are coupled though FSBs to the same MCH. Any number of different CPUs and chipsets may be used. The north bridge receives and fulfills read, write and fetch instructions from the processor cores over the FSBs. The north bridge also has an interface to system memory 367, in which instructions and data may be stored, and an interface to an ICH (Input/output Controller Hub) 365. Any one or more of the CPUs, MCH, and ICH may be combined. Alternatively, each CPU may include an MCH or ICH or both.

The MCH may also have an interface, such as a PCI Express, or AGP (accelerated graphics port) interface to couple with a graphics controller 341 which, in turn, provides graphics and possible audio to a display 337. The PCI Express interface may also be used to couple to other high speed devices. In the example of FIG. 3, six ×4 PCI Express lanes are shown. Two lanes connect to a TCP/IP (Transmission Control Protocol/Internet Protocol) Offload Engine 317 which may connect to network or TCP/IP devices such as a Gigabit Ethernet controller 339. Two lanes connect to an I/O Processor node 319 which can support storage devices 321 using SCSI (Small Computer System Interface), RAID (Redundant Array of Independent Disks) or other interfaces. Two more lanes connect to a PCI translator hub 323 which may support interfaces to connect PCI-X 325 and PCI 327 devices. The PCI Express interface may support more or fewer devices than are shown here. In addition, while PCI Express and AGP are described, the MCH may be adapted to support other protocols and interfaces instead of, or in addition to those described.

The ICH 365 offers possible connectivity to a wide range of different devices. Well-established conventions and protocols may be used for these connections. The connections may include a LAN (Local Area Network) port 369, a USB hub 371, and a local BIOS (Basic Input/Output System) flash memory 373. A SIO (Super Input/Output) port 375 may provide connectivity to a keyboard, a mouse, and other I/O devices. The ICH may also provide an IDE (Integrated Device Electronics) bus or SATA (serial advanced technology attachment) bus for connections to disk drives 387, or other large memory devices.

The particular nature of any attached devices may be adapted to the intended use of the device. Any one or more of the devices, buses, or interconnects may be eliminated from this system and others may be added. For example, video may be provided on a PCI bus, on an AGP bus, through the PCI Express bus or through an integrated graphics portion of the host controller.

5. General Matters

A lesser or more equipped optimization, process flow, or computer system than the examples described above may be preferred for certain implementations. Therefore, the configuration and ordering of the examples provided above may vary from implementation to implementation depending upon numerous factors, such as the hardware application, price constraints, performance requirements, technological improvements, or other circumstances. Embodiments of the present invention may also be adapted to other types of data flow and software languages than the examples described herein. The methods described above may be implemented using discrete hardware components or as software.

Embodiments of the present invention may be provided as a computer program product which may include a machine-readable medium having stored thereon instructions which may be used to program a general purpose computer, mode distribution logic, memory controller or other electronic devices to perform a process. The machine-readable medium may include, but is not limited to, floppy diskettes, optical disks, CD-ROMs, and magneto-optical disks, ROMs, RAMs, EPROMs, EEPROMs, magnet or optical cards, flash memory, or other types of media or machine-readable medium suitable for storing electronic instructions. Moreover, embodiments of the present invention may also be downloaded as a computer program product, wherein the program may be transferred from a remote computer or controller to a requesting computer or controller by way of data signals embodied in a carrier wave or other propagation medium via a communication link (e.g., a modem or network connection).

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known circuits, structures and techniques have not been shown in detail to avoid obscuring the understanding of this description.

While the embodiments of the invention have been described in terms of several examples, those skilled in the art may recognize that the invention is not limited to the embodiments described, but may be practiced with modification and alteration within the spirit and scope of the appended claims. The description is thus to be regarded as illustrative instead of limiting.

What is claimed is:

1. A method comprising:
calculating a similarity matrix of a first sequence against a second sequence;
determining a lowest cost path through the matrix, where cost is a function of sequence alignment;
dividing the similarity matrix into a plurality of blocks;
determining local start points on the lowest cost path, the local start points each corresponding to a block through which the lowest cost path passes;
dividing sequence alignment computation for the lowest cost path into a plurality of independent problems based on the local start points;
solving each independent problem independently; and
concatenating the solutions to generate an alignment path of the first sequence against the second sequence.

2. The method of claim 1, wherein the block size is predefined based at least in part on the size of a memory cache used for solving the problems.

3. The method of claim 1, wherein determining a lowest cost path comprises determining a plurality of low cost paths and wherein determining local start points comprises determining local start points of each path.

4. The method of claim 1, wherein determining a lowest cost path comprises determining a global end point and a global start point and wherein determining local start points comprises determining local start points between the global end point and the global start point.

5. The method of claim 1, wherein solving each problem independently comprises:
comparing each problem to a predefined block size;
solving each problem that is smaller than the block size;
solving each problem that is larger then the block size as a group of recursive sub-problem solutions;

6. The method of claim 5, wherein solving each problem as a group of recursive solutions comprises recursively decomposing each problem to less than a maximum size in a wave front parallel scheme.

7. The method of claim 1, wherein calculating the similarity matrix comprise calculating the matrix by dividing the calculations among a plurality of processors, based on the plurality of blocks.

8. The method of claim 1, wherein solving each problem independently comprises distributing the problems to a plurality of processors to be solved independently.

9. An article of manufacture comprising a machine-readable medium comprising instructions, that when executed by the machine, causes the machine to perform operations comprising:
calculating a similarity matrix of a first sequence against a second sequence;
determining a lowest cost path through the matrix, where cost is a function of sequence alignment;
dividing the similarity matrix into a plurality of blocks;
determining local start points on the lowest cost path, the local start points each corresponding to a block through which the lowest cost path passes;
dividing sequence alignment computation for the lowest cost path into a plurality of independent problems based on the local start points;
solving each independent problem independently; and
concatenating the solutions to generate an alignment path of the first sequence against the second sequence.

10. The medium of claim 9, wherein the block size is predefined based at least in part on the size of a memory cache used for solving the problems.

11. The medium of claim 9, wherein determining a lowest cost path comprises determining a plurality of low cost paths and wherein determining local start points comprises determining local start points of each path.

12. The medium of claim 9, wherein determining a lowest cost path comprises determining a global end point and a global start point and wherein determining local start points comprises determining local start points between the global end point and the global start point.

13. The medium of claim 9, wherein solving each problem independently comprises:
comparing each problem to a predefined block size;
solving each problem that is smaller than the block size;
solving each problem that is larger then the block size as a group of recursive sub-problem solutions;

14. The medium of claim 13, wherein solving each problem as a group of recursive solutions comprises recursively decomposing each problem to less than a maximum size in a wave front parallel scheme.

15. An apparatus comprising:
a plurality of processing units;
a plurality of memory units, each allocated to a processing unit;
a bus to allow data to be exchanged between the processing units; and
wherein the processing units calculate a similarity matrix of a first sequence against a second sequence, determine a lowest cost path through the matrix, where cost is a function of sequence alignment, divide the similarity matrix into a plurality of blocks, determine local start points on the lowest cost path, the local start points each corresponding to a block through which the lowest cost path passes, divide the sequence alignment computation for the lowest cost path into a plurality of independent problems based on the local start points, distribute the independent problems among the processing units, solve each independent problem in the respective processing unit, and concatenate the solutions from each processing unit to generate an alignment path of the first sequence against the second sequence.

16. The apparatus of claim 15, wherein the processing units comprise cores of a multiple core processor and the memory units comprise a cache for each core, respectively.

17. The apparatus of claim 15, wherein the processing units comprise PC nodes of a PC cluster, the memory units comprise independent system memory, and the bus comprises a local area network bus.

18. The apparatus of claim 15, wherein the block size is predefined based at least in part on the size of the respective memory units.

19. The method of claim 15, wherein determining a lowest cost path comprises determining a plurality of low cost paths and wherein determining local start points comprises determining local start points of each path.

20. The apparatus of claim 15, wherein calculating the similarity matrix comprise calculating the matrix by dividing the calculations among the plurality of processing units, based on the plurality of blocks.
